(19) United States
(12) Patent Application Publication
(10) Pub. No.: US 2010/0289956 A1
(43) Pub. Date: Nov. 18, 2010

(54) Portable film-image-digitizing scanner with a hidden image-displaying screen

(76) Inventor: Chun Chieh Hsu, Hsichih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,445

(22) Filed: May 12, 2009

(51) Int. Cl. H04N 7/00; H04N 1/04

(52) U.S. Cl. 348/552; 358/474; 348/E07.001

(57) ABSTRACT

A portable film-image-digitizing scanner with a hidden image-displaying screen includes a machine body and an image-processing device. A picture-taking lens is set inside the said body and a backlight mechanism is set under the base brace. Film insert-laying grooves are set at two sides of the body to provide an insertion from one side for a film clip. And, the image-processing device includes several control buttons, a memory card slot and a cover plate set with the hidden image-displaying screen (TFT-LCD, thin film transistor liquid crystal display). The film clip can fix and set the films inside it and position them on top of the backlight mechanism. The film images are accessed by using the picture-taking lens, and transformed into digitizing data through the image-processing device. The images can then be displayed on the image-displaying screen directly for a direct editing or modifying, or be wire-transferred to TV (television) for displaying. Thus, it can achieve the purpose of fast transforming the film images into digitized data through a single machine for editing, modifying, displaying, or storage to improve the practicality.

### BACKGROUND OF THE INVENTION

The image recording method in the early days mainly is using traditional camera that the photosensitive films (positive or negative film) are set to access the images then these films are washed by chemicals to become the known photos for watching and savoring. Due to these known films are made of plastic material and hard to be stored, they are easily damaged or lost after a period of time and unable to be re-washed to get the original stored images. It thus often caused the users to feel regretful. Furthermore, the images stored in the known films are also under fixed status and unable to be modified. This is also a flaw while using.

Due to the known flaws, the present inventor thus designs a kind of transforming device to get the obvious improvement which can transform the images on the film into digitizing data rapidly and has applied a British patent application with filing number 0803923.2. Its structures are shown as FIGS. 1 and 2, which include a machine body 1, a rack body 2, a base brace 3, and a base cover 4. A group of electrical circuit board 5 set on top of the rack body 2 is composed of a picturing talking lens 51. The base brace 3 is linked under the rack body 2 with a backlight mechanism 31 set inside. Two insert-laying grooves 11 are formed between two sides of machine body 1 and the base cover 4. It can further combine with a linking cable 13 such that the internal circuit can be transferred to a computer through a linking head 131. As shown in FIGS. 3 and 4, the said device further is set with a positive film clip 6 and a negative a film clip 7 which can be opened or closed simply to provide a laying-in for positive or negative films 63, 73. While using, the film clip 6 clipped with films is inserted in from the inlet of insert-laying groove 11 in the machine body 1 such that the films in certain square aperture aim at the picture-taking lens 51. And, after that, through the control of computer via the linking cable 13 or direct pressing on the buttons 14, the backlight mechanism 31 can be started to emit the light then project to the films. After being taken and accessed by the picture-taking lens 51, the images are processed by programs to be transformed into digitizing data and transferred to the computer for modifying or storage. Then, the film clip 6 can be pushed again to move toward the outlet end for dealing the image accessing of the next film.

Although this kind of device can transform the images stored in the films rapidly into digitizing data, it however needs to combine with the computer then can proceed the digitizing of image data and editing-storage. It is unable to be operated independently and therefore has the problem of inconvenience.

### SUMMARY OF THE INVENTION

For this, the present inventor thus studies and researches again then designs out a machine which can transform the images on the film into digitizing data rapidly through a single machine, proceed a direct editing or modifying to the image data, and achieve the effect of fast storage. That is, the present invention is related to a kind of portable film-image-digitizing scanner with a hidden image-displaying screen. Through a single machine, by its internal backlight mechanism combined with the picture-taking lens and under simple operations, the images on the films are transformed into digitizing data rapidly by its image-processing device. And, it is set with a memory card for storing the digitizing data directly. It is further combined with the hidden typed image displaying screen for the benefit of direct image modifying or editing and can prevent the displaying screen from being damaged. Now, accompanying with drawings, the character and structure of the present invention will be disclosed as following.

### BRIEF DESCRIPTION OF THE DRAWINGS

FIG. 1 is a three-dimensional outside appearance diagram of the prior product.

FIG. 2 is a sectional diagram of the implementing structure in prior product.

FIG. 3 is a three-dimensional diagram of the positive film clip.

FIG. 4 is a three-dimensional diagram of the negative film clip.

FIG. 5 is a three dimensional outside appearance diagram in the present invention.

FIG. 6 is a three-dimensional diagram of a liftable cover plate in the present invention.

FIG. 7 is a partial sectional plane diagram of FIG. 5.

FIG. 8 is a partial sectional plane diagram of FIG. 6.

FIG. 9 is an implementing status diagram of the present invention.

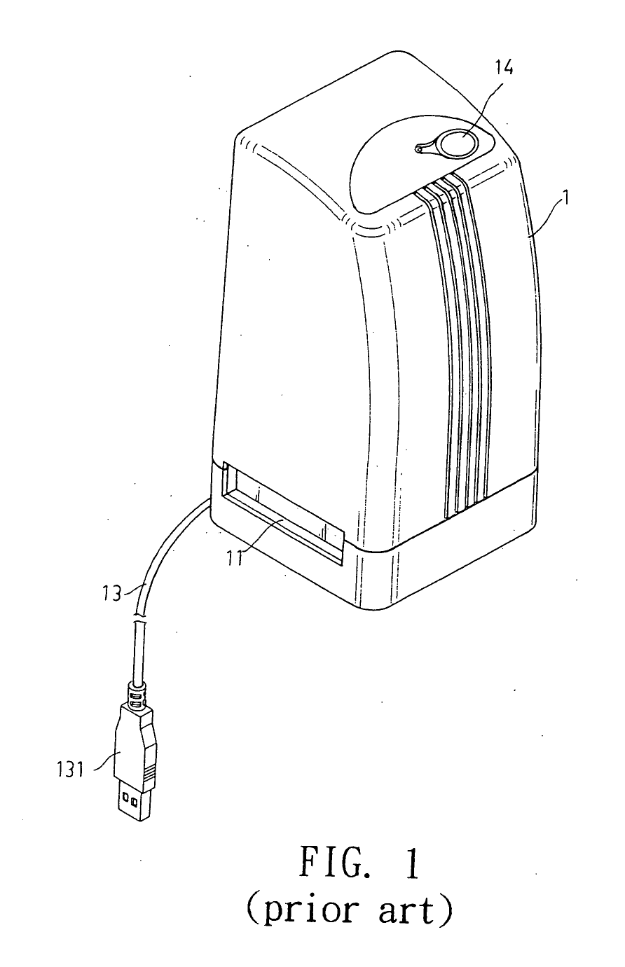

### DETAILED DESCRIPTION OF THE PREFERRED EMBODIMENT

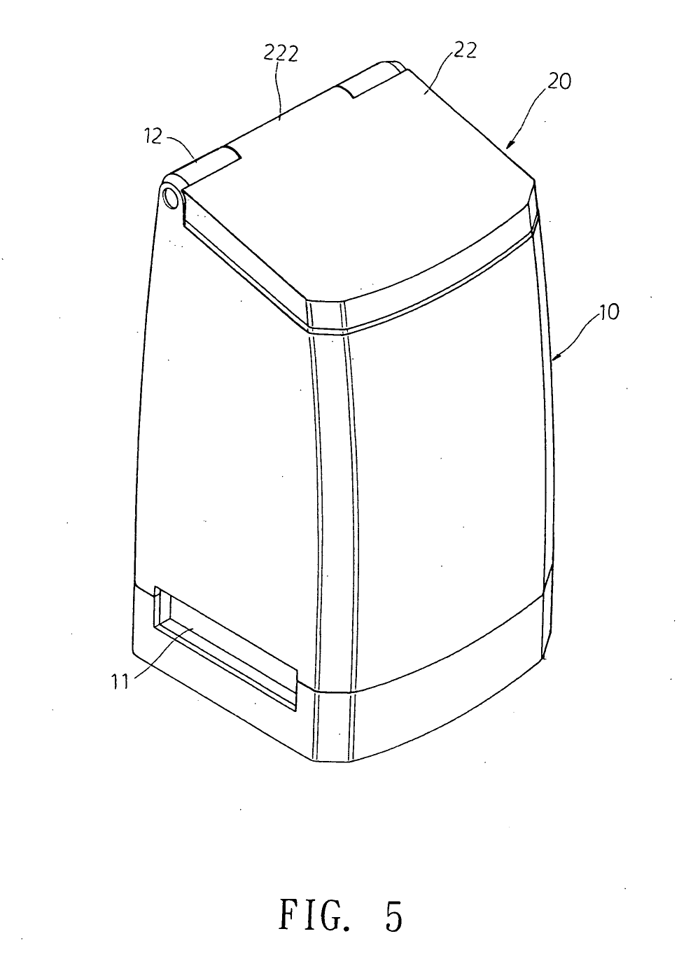

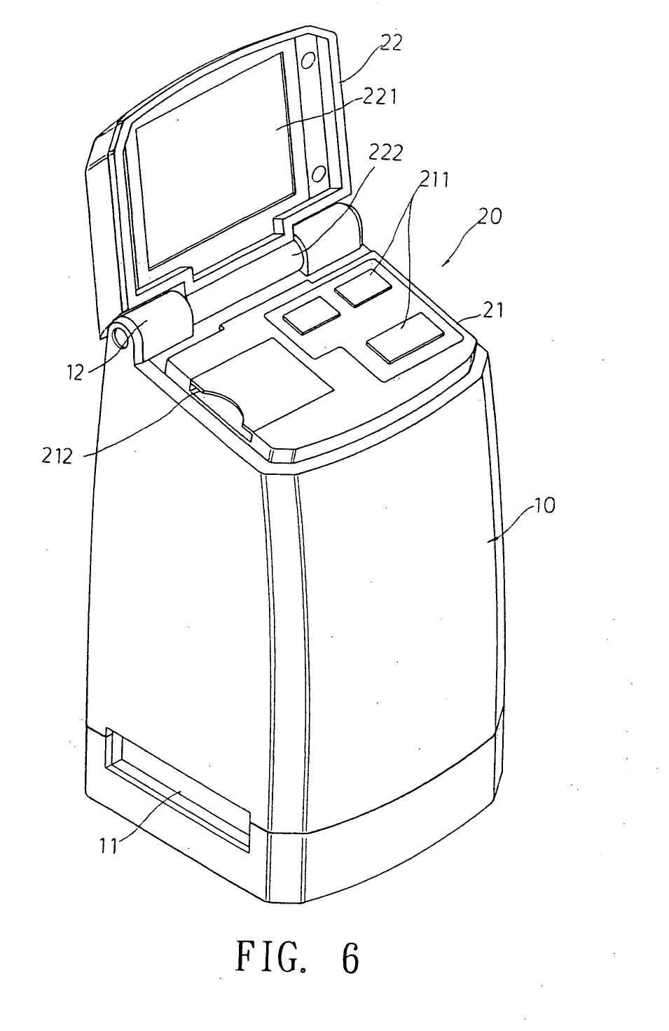

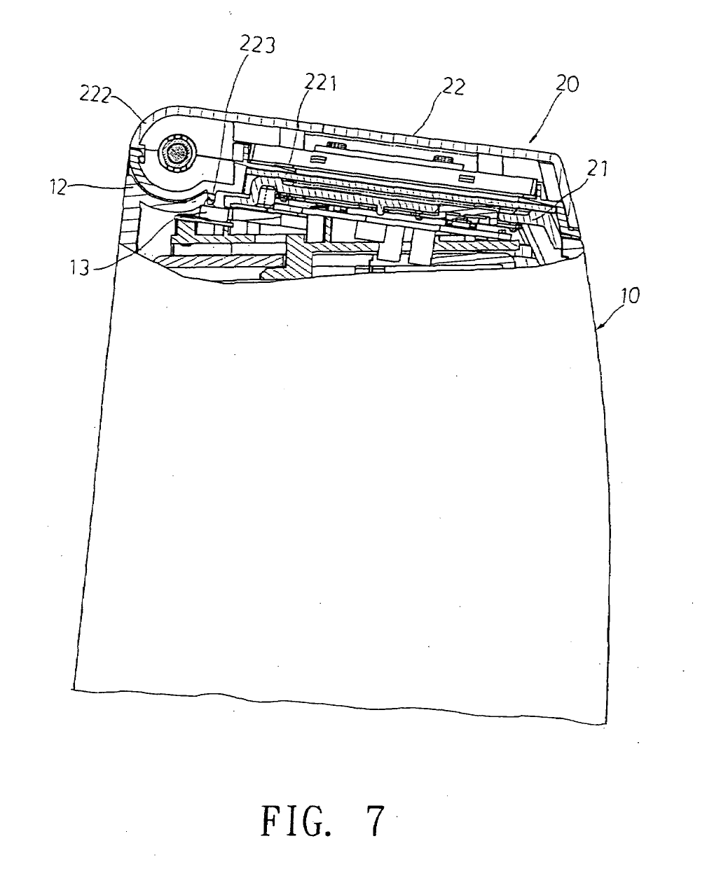

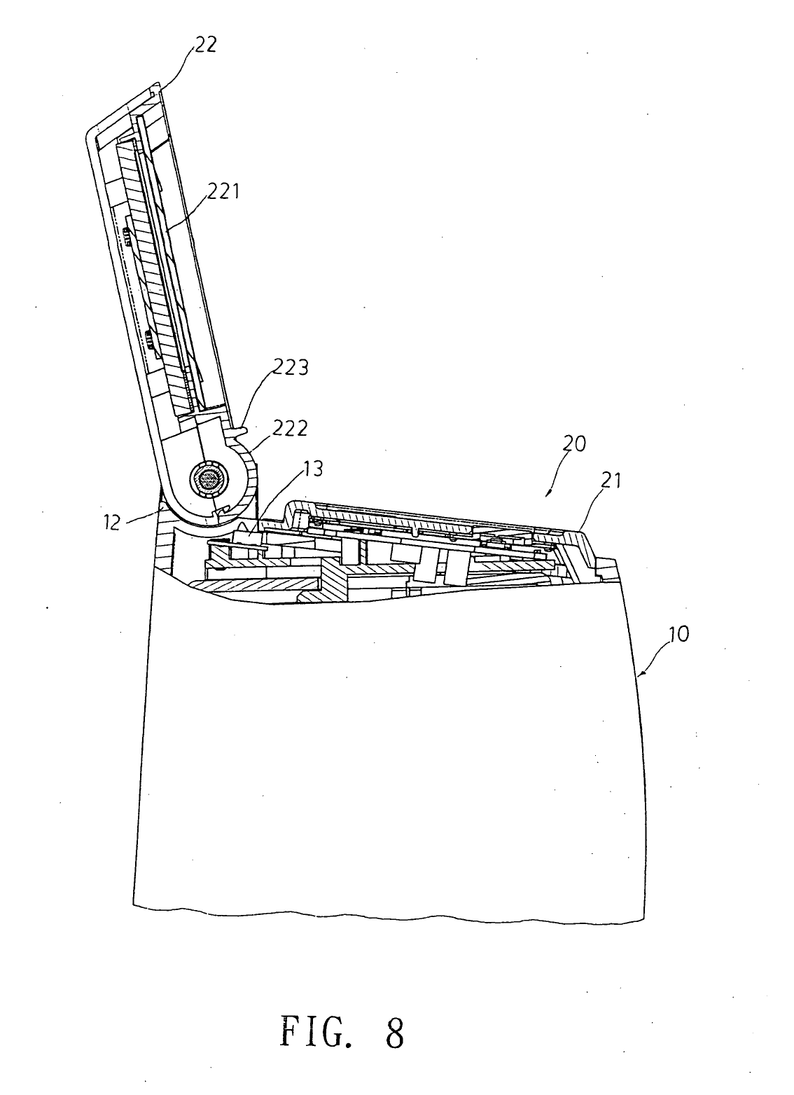

The present invention is a portable film image-digitizing scanner with a hidden image-displaying screen that aims mainly to be an improvement in the aforementioned transformation device capable of fast transforming the film images into digitizing data. Please refer to those shown in FIGS. 5 to 8. The present invention includes a machine body 10 with a liftable cover plate 22 combined on top and is further set with an image-processing device 20 having a main body 21, several control buttons 211 and a memory card slot 212. A hidden image-displaying screen 221 is set at inner side face of the cover plate 22. A rotating support seat 12 is set on top of the machine body 10 to provide a linking for a rotating portion 222 of cover plate 22 and the same known picture-taking lens, backlight mechanism, and image transforming software are also set inside the machine body 10. The film insert-laying grooves 11 penetrating from left to right are also set at two sides of the machine body. Furthermore, a touch-pressing body 223 is set on the rotating portion 222 of cover plate 22, and a touch-pressing switch 13 having a touch-pressing fit with the touch-pressing body 223 is set at the relative position between the machine body 10 and the touch-pressing body 223.

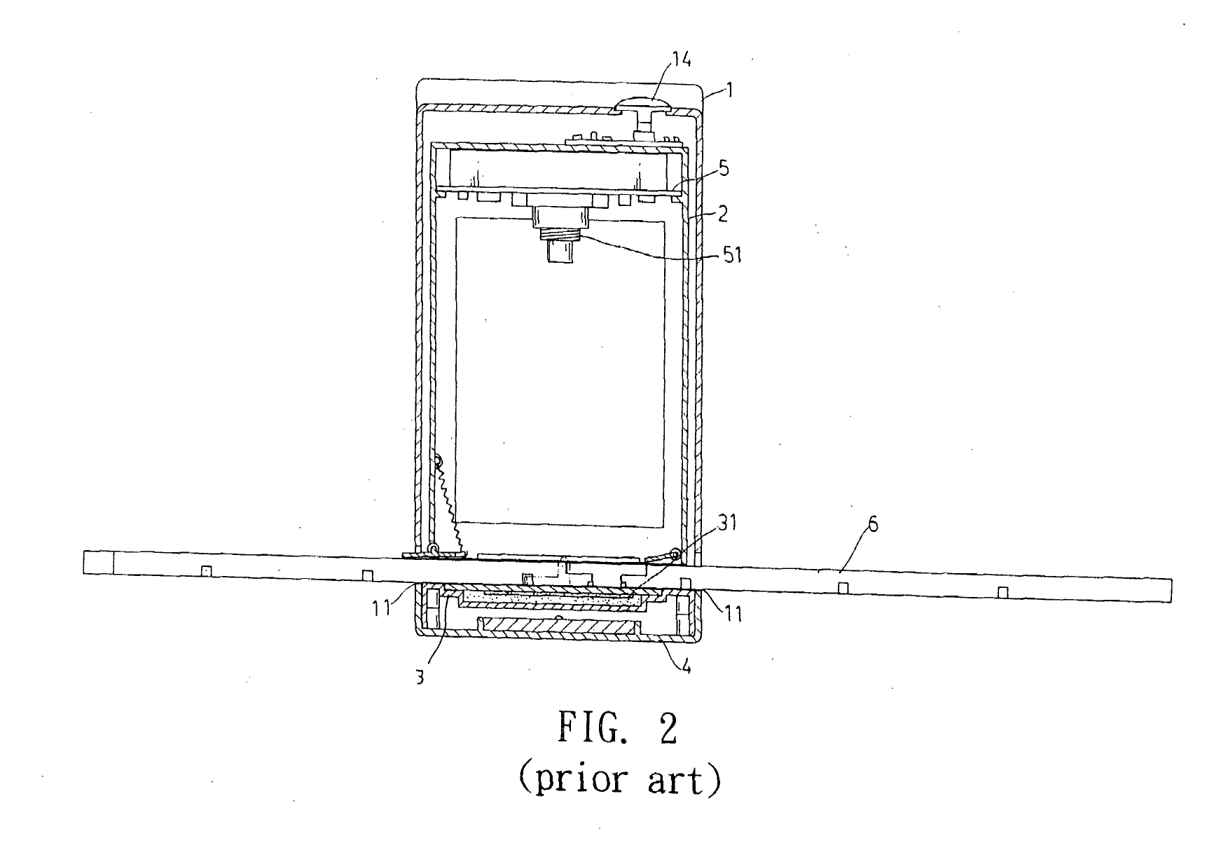

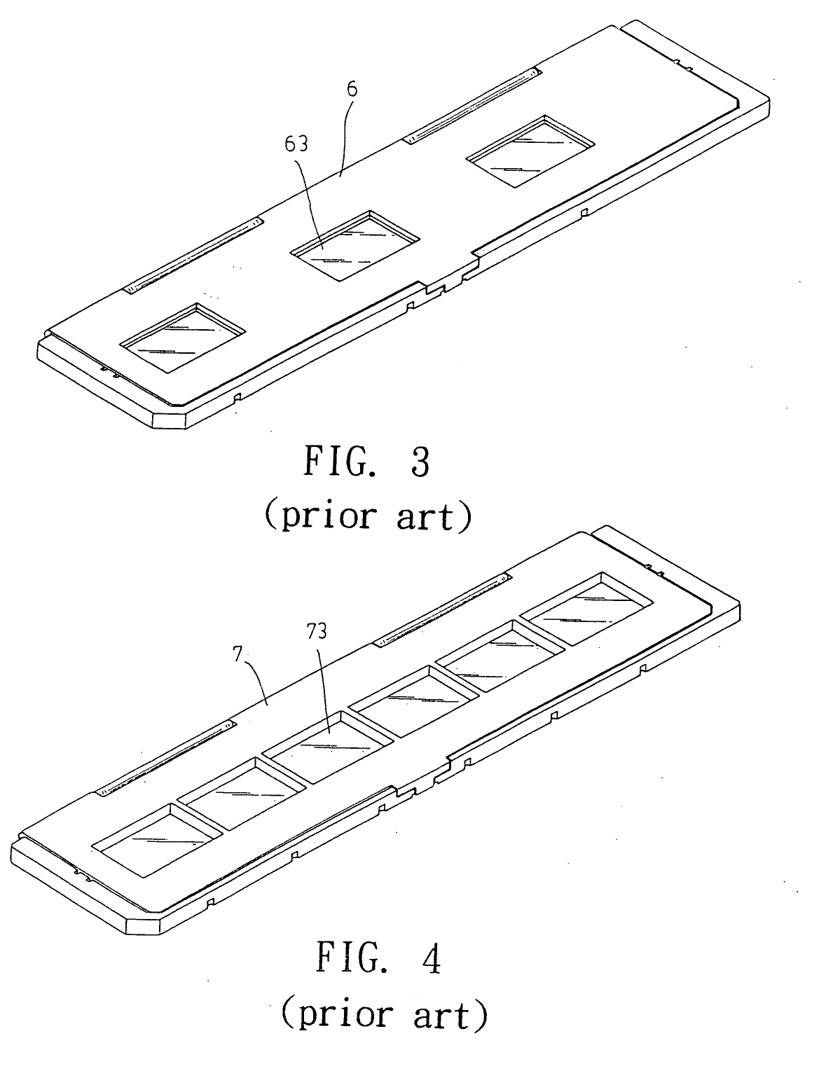

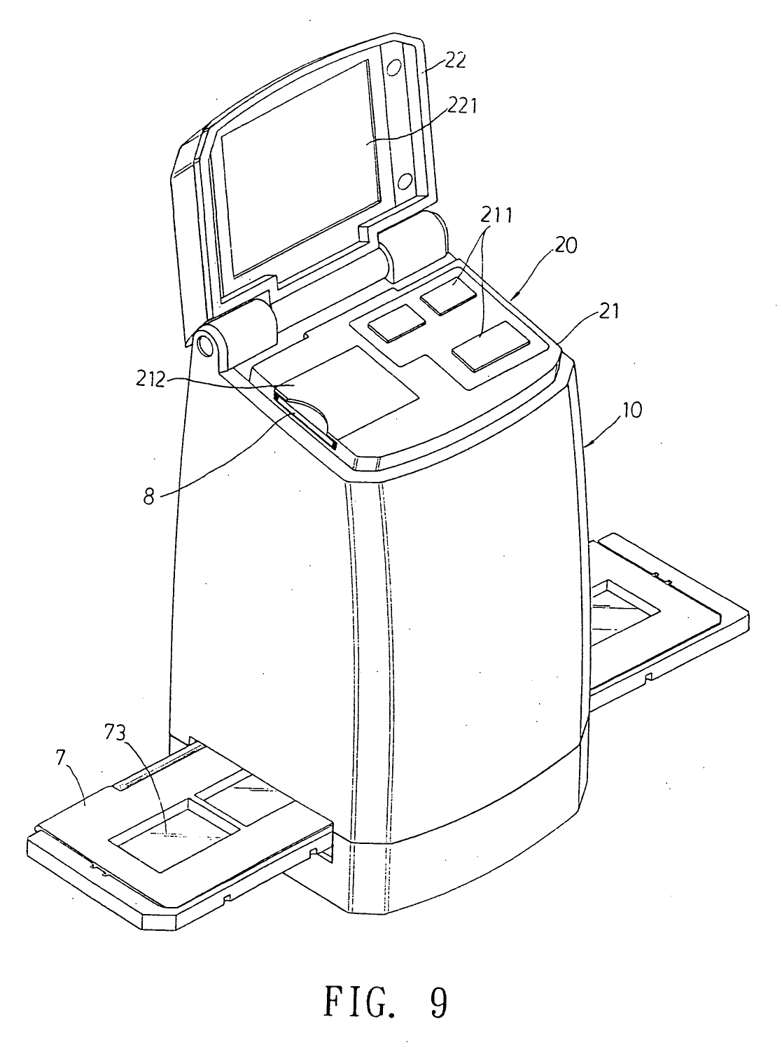

Please accompanying with FIG. 9. While using (taking negative film 73 as an explanatory example), the present invention also inserts the film clip 7 clipped with films in from one end of insert-laying groove 11 in the machine body 10 and turns over the cover plate 22 such that the touch-pressing body 223 rotates to relief the touch-pressing action with touch-pressing switch 13 and automatically power on. At this time, the films 73 in certain square aperture of film clip 7 aims at the picture-taking lens in the machine body 10 (please refer to those shown in FIG. 2). And, after that, through the pressing of buttons 211 in the main body 21, the backlight mechanism 31 can be started to emit the light then project to the films. After being taken and accessed by the picture-taking lens, the images are processed by programs to be transformed into digitizing data. And, the film images are displayed on the image-displaying screen (for example, as the TFT-LCD) in the inner side of cover plate 22. Furthermore, a memory care 8 can be inserted in the memory card slot 212 of main body 21 and the images can be stored directly in the memory card 8 through the operate-control of control buttons 211. Then, the film clip 7 can be pushed again to move toward the outlet end for proceeding the image accessing of the next film. After all films in the same film clip have been accessed and transformed, the film clip 7 is taken out from the other end of the film insert-laying grooves 11 and able to replace the inside films again. By proceeding continuously the aforementioned operations, the object of image accessing is thus completed easily.

Furthermore, the present invention can also set with a terminal linking hole (not shown in figure) to provide a combination with cable connecting and form a linking with TV or other large sized image-displaying devices, and the accessed digitizing image data can be clearly broadcasted.

Through the operations of the single machine, the present invention can transform the images on the positive films or negative films into digitizing data simply and rapidly. And, the image-displaying screen in the machine body can be used to proceed a prompt editing and modifying of the image data. It thus provides a more convenient and practical function. Furthermore, the image-displaying screen in the machine body and control buttons are hidden and covered by the cover plate while not being used. It thus can achieve the effects protecting the displaying screen from being damaged and prevent the being mistakenly touched. And, opening and closing the cover plate are meant also a power on and power off functions for the main machine's power. The above are all conformed to the conditions of improving effect in patents, and we thus file the application according to the law.

I claim:

1. A portable film-image-digitizing scanner with a hidden image-displaying screen including a machine body with a picture-taking lens set inside and a base brace with a backlight mechanism set inside, and film insert-laying grooves are set at two sides of the body to provide an insertion from one, side for a film clip combined with negative or positive films to access the images and transform them into digitizing data; an image-processing device further set in the body includes a main body with several control buttons and a memory card slot and combines with a liftable cover plate with a hidden image-displaying screen set in its side face that the image-displaying screen and each control buttons are hidden in the cover plate while the scanner is not used.

2. A portable film-image-digitizing scanner with a hidden image-displaying screen as claimed in claim 1 wherein a rotating support seat is set on top of the machine body to provide a pivoting for a rotating portion of cover plate and a touch-pressing body is set on the rotating portion of cover plate, and a touch-pressing switch having a touch-pressing fit with the touch-pressing body is set at the relative position between the machine body and the touch-pressing body to control the start or on/off of the scanner.

3. A portable film-image-digitizing scanner with a hidden image-displaying screen as claimed in claim 1, wherein the machine is set with a terminal linking hole to provide a linking with TV or other large sized image-displaying devices for the provision of clear broadcasting through a connecting wire.
